(19) United States
(12) Patent Application Publication
(10) Pub. No.: US 2006/0141942 A1
(43) Pub. Date: Jun. 29, 2006

(54) Wireless stereo synchronizaing transceiver

(75) Inventor: Ming-Lung Yang, Hong Kong (CN)

Correspondence Address: BACON & THOMAS, PLLC, 625 SLATERS LANE, FOURTH FLOOR, ALEXANDRIA, VA, 22314, US

(73) Assignee: SEIKAKU TECHNICAL GROUP LIMITED, HONG KONG (CN)

(21) Appl. No.: 11/144,655

(22) Filed: Jun. 6, 2005

(30) Foreign Application Priority Data
Dec. 29, 2004 (CN) 200420122296.6

(51) Int. Cl. H04B 1/38

(52) U.S. Cl. 455/76; 455/73

(57) ABSTRACT

A wireless stereo synchronizing transceiver is disclosed to include a receiving processing unit having a mixer circuit, a transmitting processing unit, which has a stereo modulating mixing circuit and a first voltage control oscillator circuit connected to the stereo modulating mixing circuit, and a synchronizing processing unit, which has a second voltage control oscillator circuit connected to the mixer circuit of the receiving processing unit, a frequency synthesizer being electrically connected in parallel to the first voltage control oscillator circuit and the second voltage control oscillator circuit, and a processor electrically connected to the frequency synthesizer.

### BACKGROUND OF THE INVENTION

1. Field of the Invention

The present invention relates generally to a transceiver and more particularly, to a wireless stereo synchronizing transceiver.

2. Description of the Related Art

A conventional wireless transmission apparatus generally comprises a transmitter and a receiver separately provided for transmitting or receiving signal. In order to reduce the size and to save the cost, the transmitter and the receiver may be set in a common base, forming a transceiver. However, because the transmitting circuit and the receiving circuit of a transceiver are two independent circuits, the circuit design is still complicated, resulting in a high cost.

### SUMMARY OF THE INVENTION

The present invention has been accomplished under the circumstances in view. It is one object of the present invention to provide a wireless stereo synchronizing transceiver, which allows the apparatus to receive wireless signal and to transmit wireless signal at the same time. It is another object of the present invention to provide a wireless stereo synchronizing transceiver, which greatly reduces the number of parts and dimensions of the apparatus, and simplifies the circuit design.

To achieve these and other objects of the present invention, the wireless stereo synchronizing transceiver comprises a receiving processing unit, which comprises a mixer circuit, a transmitting processing unit, which comprises a stereo modulating mixing circuit and a first voltage control oscillator circuit electrically connected to the stereo modulating mixing circuit, and a synchronizing processing unit, which comprises a processor, a frequency synthesizer electrically, and a second voltage control oscillator circuit. The processor is electrically connected to the frequency synthesizer. The frequency synthesizer is electrically connected in parallel to the first voltage control oscillator circuit and the second voltage control oscillator circuit. The second voltage control oscillator circuit is electrically connected to the mixer circuit of the receiving processing unit.

### BRIEF DESCRIPTION OF THE DRAWINGS

FIG. 1 is a system block diagram of the present invention.

FIG. 2 is a circuit diagram of the present invention.

### DETAILED DESCRIPTION OF THE INVENTION

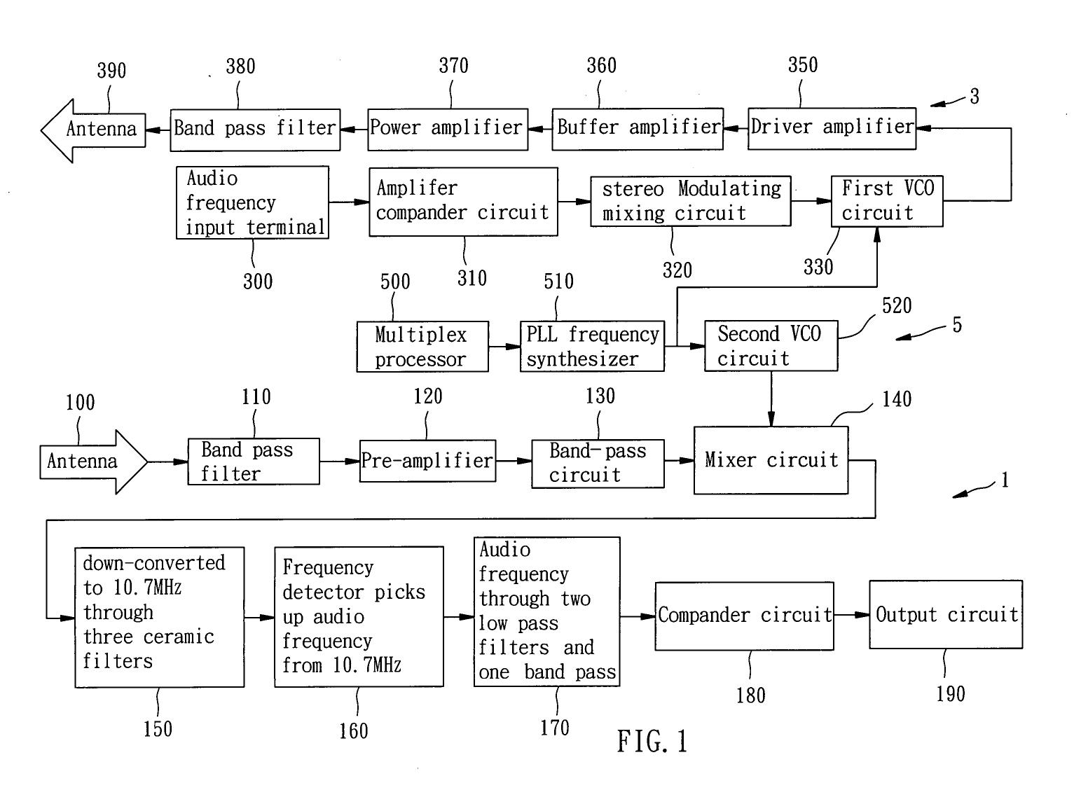

Referring to FIG. 1, a wireless stereo synchronizing transceiver in accordance with the present invention generally comprises a receiving processing unit 1, a transmitting processing unit 3, and a synchronizing processing unit 5.

The receiving processing unit 1 comprises:

an antenna 100 for receiving wireless signal;

a band pass filter 110 electrically connected to the antenna 100;

a pre-amplifier 120 electrically connected to the band pass filter 110;

a band-pass circuit 130 electrically connected to the pre-amplifier 120;

a mixer circuit 140 electrically connected to the band-pass circuit 130;

a down-converter 150 electrically connected to the mixer circuit 140;

an intermediate frequency processor 160 electrically connected to the down-converter 150;

a low frequency processor 170 electrically connected to the intermediate frequency processor 160;

an compander circuit 180 electrically connected to the low frequency processor 170; and

an output circuit 190 electrically connected to the compander circuit 180 for outputting audio frequency signal to external audio output devices.

The transmitting processing unit 3 comprises:

an audio frequency input terminal 300;

an amplifier compander circuit 310 electrically connected to the audio frequency input terminal 300;

a stereo modulating mixing circuit 320 electrically connected to the amplifier compander circuit 310;

a first VCO (Voltage Control Oscillator) circuit 330 electrically connected to the stereo modulating mixing circuit 320;

a driver amplifier 350 electrically connected to the first VCO circuit 330;

a buffer amplifier 360 electrically connected to the driver amplifier 350;

a power amplifier 370 electrically connected the buffer amplifier 360 and forming with the driver amplifier 350 and the buffer amplifier 360 an amplifier assembly;

a band pass filter 380 electrically connected to the power amplifier 370; and

an antenna 390 electrically connected to the band pass filter 380.

The synchronizing processing unit 5 comprises a multiplex processor 500, a frequency synthesizer, for example, a PLL (Phase Locked Loop) frequency synthesizer 510, and a second VCO (Voltage Control Oscillator) circuit 520. The multiplex processor 500 is electrically connected to the PLL frequency synthesizer 510. The PLL frequency synthesizer 510 is connected in parallel to the first VCO circuit 330 and the second VCO (Voltage Control Oscillator) circuit 520. The second VCO circuit 520 is electrically connected to the mixer circuit 140 of the receiving processing unit 1.

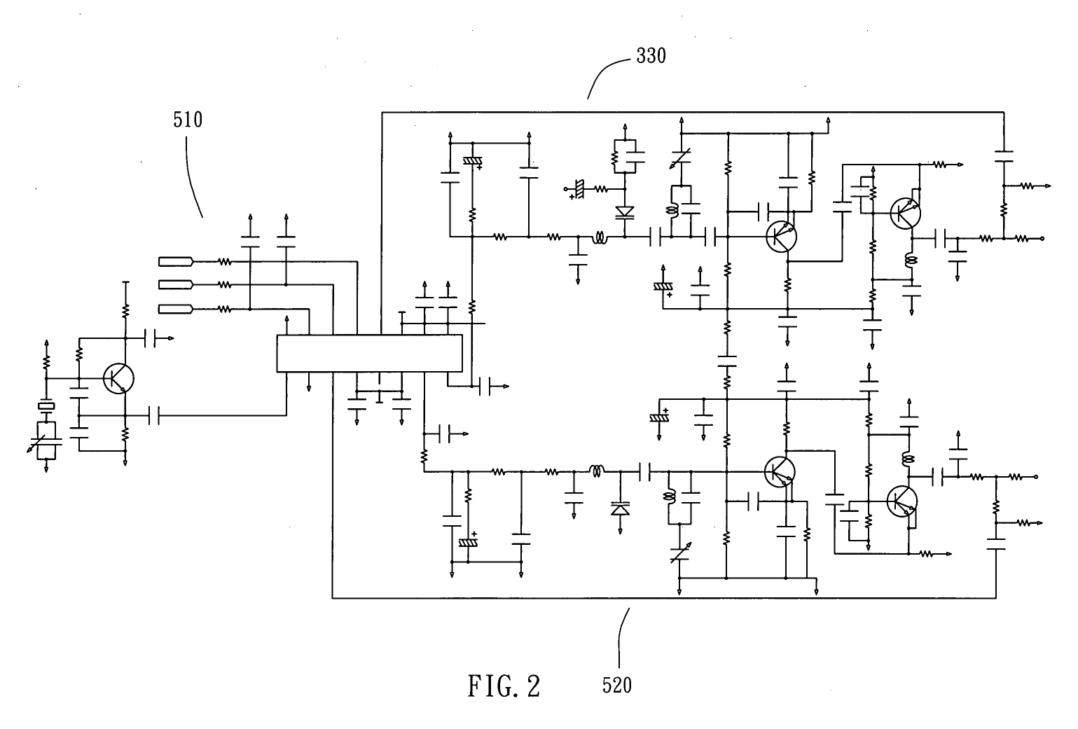

Referring to FIG. 2, by means of the multiplex processor 500 and the PLL frequency synthesizer 510, the synchronizing processing unit 5 controls the first VCO circuit 330 as well as the second VCO circuit 520. Further, because the second VCO circuit 330 is electrically connected to the mixer circuit 140 of the receiving processing unit 1, the synchronizing processing unit 5 controls the receiving processing unit 1 and the transmitting processing unit 3 to work at the same time, i.e., the invention allows signal receiving and signal transmitting at the same time.

As indicated above, the invention has the following features:

1. The wireless stereo synchronizing transceiver of the present invention allows the apparatus to receive wireless signal and to transmit wireless signal at the same time.

2. The wireless stereo synchronizing transceiver of the present invention reduces the number of parts and dimensions of the apparatus, and simplifies the circuit design.

What is claimed is:

1. A wireless stereo synchronizing transceiver comprising:
a receiving processing unit, said receiving processing unit comprising a mixer circuit;
a transmitting processing unit, said transmitting processing unit comprising a stereo modulating mixing circuit and a first voltage control oscillator circuit electrically connected to said stereo modulating mixing circuit; and
a synchronizing processing unit, said synchronizing processing unit comprising a processor, a frequency synthesizer electrically, and a second voltage control oscillator circuit, said processor being electrically connected to said frequency synthesizer, said frequency synthesizer being electrically connected in parallel to said first voltage control oscillator circuit and said second voltage control oscillator circuit, said second voltage control oscillator circuit being electrically connected to said mixer circuit of said receiving processing unit.

2. The wireless stereo synchronizing transceiver as claimed in claim 1, wherein said transmitting processing unit further comprises an amplifier assembly electrically connected to said first voltage control oscillator circuit.

3. The wireless stereo synchronizing transceiver as claimed in claim 2, wherein said amplifier assembly comprises a driver amplifier electrically connected to said first voltage control oscillator circuit, a buffer amplifier electrically connected to said diver amplifier, and a power amplifier electrically connected to said buffer amplifier.

4. The wireless stereo synchronizing transceiver as claimed in claim 1, wherein said mixer circuit of said receiving processing unit is electrically connected between a band pass circuit and a down-converter.

5. The wireless stereo synchronizing transceiver as claimed in claim 1, wherein said frequency synthesizer of said synchronizing processing unit is a PLL (Phase Locked Loop) frequency synthesizer.
